(19) United States
(12) Patent Application Publication
(10) Pub. No.: US 2006/0239498 A1
(43) Pub. Date: Oct. 26, 2006

(54) Power-tolerant assembly for combining a sound ring and a diaphragm of speaker

(76) Inventor: Jui-Cheng Chang, Taichung (TW)

Correspondence Address: CHANG JUI-CHENG, 235 Chung - Ho, Box 8-24, Taipei, TW

(21) Appl. No.: 11/113,220

(22) Filed: Apr. 25, 2005

(51) Int. Cl. H04R 9/06

(52) U.S. Cl. 381/407

(57) ABSTRACT

A power-tolerant assembly for combining a sound ring and a diaphragm of a speaker comprises a disk frame having a magnetic inducing body; a vibration diaphragm installed upon the disk frame; the vibration diaphragm having an annular lower ring section; a distal end of the annular lower ring section being bent as an L shape or U shape; and a sound ring within the vibration diaphragm; the magnetic inducing body being located below the sound ring; two sides or three sides of the sound ring being combined to the L or U shape distal end for increasing the combining area and strength of the combination of the adhering portion and the sound ring. Or a dust-proof cover is installed upon an upper side of the sound ring; the vibration diaphragm having an annular lower side; a lower distal end of the annular lower end being bent so as to enclose the sound ring.

### FIELD OF THE INVENTION

The present invention relates to speakers, and in particular to a power-tolerant assembly for combining a sound ring and a diaphragm of a speaker, wherein the vibration diaphragm can be adhered to the sound ring firmly so as to have preferred power tolerant ability and preferred sound effect.

### BACKGROUND OF THE INVENTION

With the improvement of wireless communication, speakers have become a popular and necessary products in current wireless communication.

In the prior art, the way for combining the sound ring and vibration diaphragm of the speaker is performed by adhering the vibration diaphragm to an upper side the sound ring. However the area of the sound ring is finite and thus the combining area of the vibration diaphragm and the sound ring is small so that the strength of the combining is weak and the sound ring is easy to separate from the vibration diaphragm.

Thus, in one prior art, copper wires serve to enclose a thin film cylindrical sound ring. A top of the sound ring is sealed so as to be wholly adhered to the lower side of the vibration diaphragm to increase the area of the combination. However this way will affect the sound quality due to the center portion of the vibration diaphragm is wholly adhered to the sound ring. Thus the sound is distorted.

In another prior art design, a through hole is formed in the vibration diaphragm and the top surface of the thin film cylindrical sound ring is formed as a found cambered surface. The periphery of the cambered surface is formed as an adhering surface. Thereby the adhering surface serves to be combined to the periphery of the through hole of the vibration diaphragm so as to improve the prior art defect.

### SUMMARY OF THE INVENTION

Accordingly,. the primary object of the present invention is to provide a power-tolerant assembly for combining a sound ring and a diaphragm of a speaker, where the vibration diaphragm can be adhered to the sound ring firmly so as to have preferred power tolerant ability and preferred sound effect.

To achieve above objects, the present invention provides a power-tolerant assembly for combining a sound ring and a diaphragm of a speaker. The assembly comprises a disk frame having a magnetic inducing body at a center thereof for generating magnetic field; a vibration diaphragm installed upon the disk frame; the vibration diaphragm having an annular lower ring section, a distal end of the annular lower ring section being bent as an L shape or U shape; and a sound ring within the vibration diaphragm; the magnetic inducing body being located below the sound ring; two sides or three sides of the sound ring being combined to the L shape distal end of the vibration diaphragm for increasing the combining area and strength of the combination of the adhering portion and the sound ring.

A power-tolerant assembly for combining a sound ring and a diaphragm of a speaker which comprises a disk frame having a magnetic inducing body at a center thereof for generating magnetic field; a vibration diaphragm installed upon the disk frame; a sound ring installed within the vibration diaphragm; the magnetic inducing body being located below the sound ring; a dust-proof cover installed upon an upper side of the sound ring; the vibration diaphragm having an annular lower side; a lower distal end of the annular lower end being bent as an L shape and U shape; two sides or three sides of the sound ring being combined to the L shape distal end of the vibration diaphragm for increasing the combining area and strength of the combination of the adhering portion and the sound ring.

The various objects and advantages of the present invention will be more readily understood from the following detailed description when read in conjunction with the appended drawing.

### BRIEF DESCRIPTION OF THE DRAWINGS

FIG. 1 is an exploded cross sectional view of the power-tolerant assembly for combining a sound ring and a diaphragm of a speaker of the present invention.

FIG. 2 is a partial cross sectional view of FIG. 1 of the present invention.

FIG. 3 is an assembled cross sectional view of the power-tolerant assembly for combining a sound ring and a diaphragm of a speaker according to the present invention.

FIG. 4 is a partial cross sectional view of FIG. 3.

FIG. 5 is an assembled cross sectional view of the second embodiment of the present invention.

FIG. 6 is an exploded cross sectional view of FIG. 5.

FIG. 7 is an exploded cross sectional view showing the structure of third embodiment of the present invention.

FIG. 8 is an assembled cross sectional view of the third embodiment of the present invention.

FIG. 9 is a partial enlarged cross sectional view of the third embodiment of the present invention.

FIG. 10 is a cross sectional view about the assembly of fourth embodiment of the present invention.

FIG. 11 is a partial enlarged cross sectional view of the fourth embodiment of the present invention.

### DETAILED DESCRIPTION OF THE INVENTION

In order that those skilled in the art can further understand the present invention, a description will be described in the following in detail. However, these descriptions and the appended drawings are only used to cause those skilled in the art to understand the objects, features, and characteristics of the present invention, but not to be used to confine the scope and spirit of the present invention defined in the appended claims.

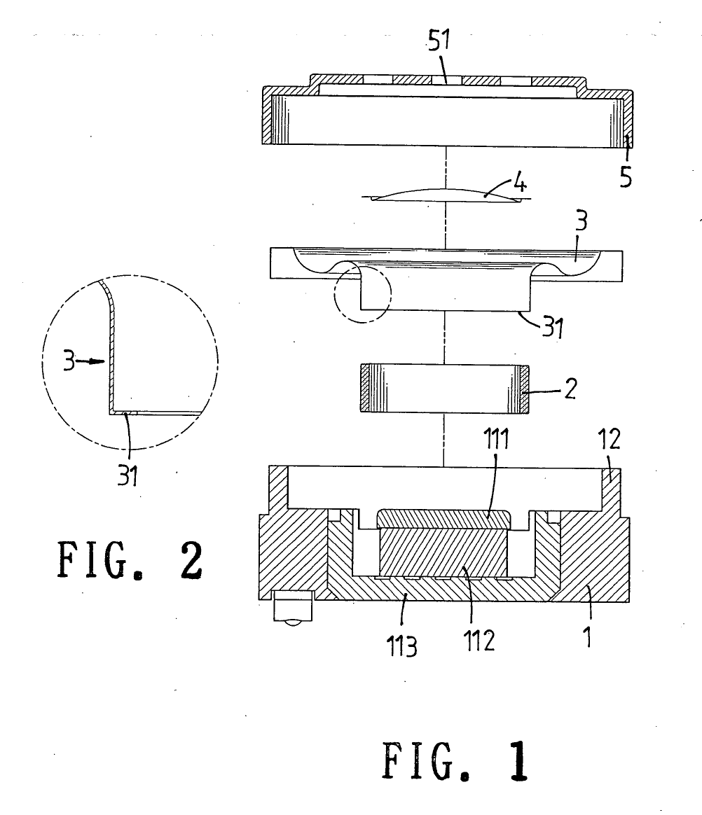

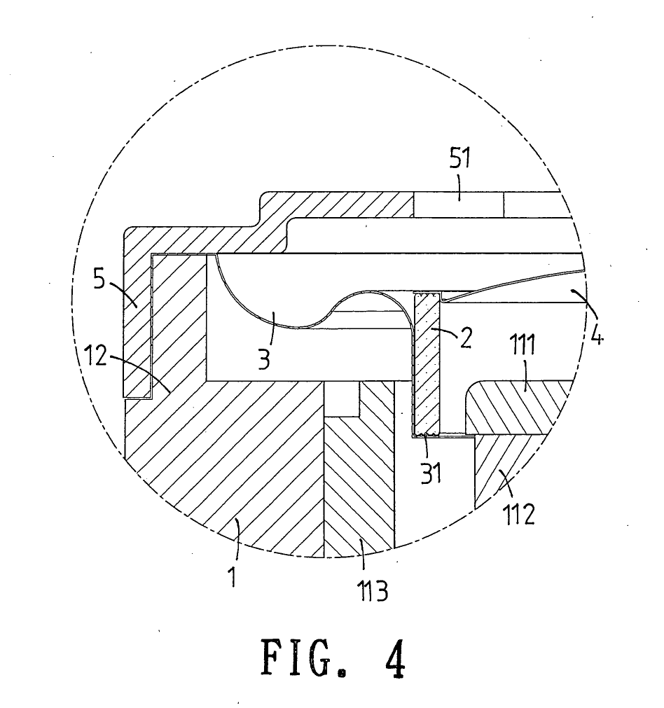

Referring to FIGS. 1 to 4, the power-tolerant assembly for combining a sound ring and a diaphragm of a speaker of the present invention will be described herein. The present invention has the following elements.

A disk frame 1 has a magnetic inducing body at a center thereof. The magnetic inducing body is formed by an electrode sheet 111, a lower sheet 113 and a magnet 112 for generating magnetic lines. The magnetic inducing body serves to generate magnetic field required by the sound ring 2. An upper outer side of the disk frame 1 has a positioning portion 12 for installing a vibration diaphragm 3 and for fixing the vibration diaphragm 3 by using the front cover 5.

A sound ring 2 is formed by a metal ring. The sound ring 2 will vibrate due to the magnetic field generated by the magnetic inducing body so as to drive the vibration diaphragm 3 to vibrate.

The vibration diaphragm 3 is a round disk. The vibration diaphragm 3 has an annular shape. A cross section of the distal end of the vibration diaphragm 3 has an L shape for increasing the adhering area between the sound ring 2 and the vibration diaphragm 3 by the L shape area of the adhering portion 31 and the outer side and lower side of the sound ring 2 so as to increase the combining strength and power-tolerance of the sound ring 2 and the vibration diaphragm 3.

A dust-proof cover 4 serves for preventing dust or other impurities from falling into the sound ring 2 to affect the sound quality of the speaker. The dust-proof cover 4 is fixed upon an upper side of the sound ring 2.

A front cover 5 has plurality of sound holes 51 at a center portion thereof for transferring the sound from the vibration diaphragm 3. Two sides of the front cover 5 serves for engaging with the positioning portion 12 of the disk frame 1 and for clamping the vibration diaphragm 3.

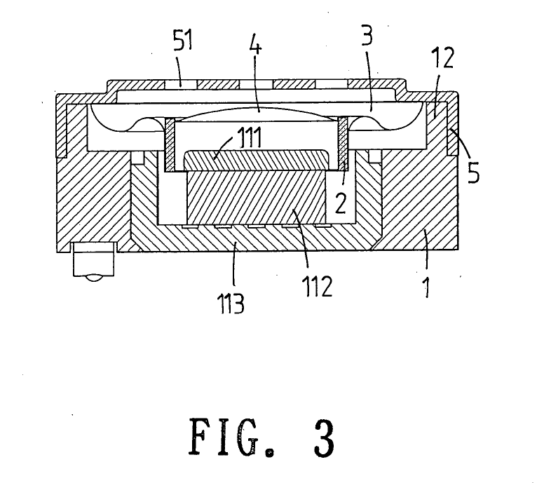

In assembly of the present invention, the sound ring 2 is adhered to the adhering portion 31 of the vibration diaphragm 3. By the L shape of each side of the adhering portion 31 to combine with the outer side and lower side of the sound ring 2 to tightly combine the sound ring 2 to the vibration diaphragm 3. This way is different from the prior art. Then the dust-proof cover 4 is adhered upon the upper side of the sound ring 2 so as to prevent dust or impurities from falling into the sound ring 2. Then the vibration diaphragm 3 is engaged to the positioning portion 12 of the disk frame 1 so that the sound ring 2 is positioned between the lower sheet 113 and electrode sheet 111 of the magnetic inducing body. Finally, the front cover 5 is located upon the positioning portion 12 of the disk frame 1 for fixing the vibration diaphragm 3. Thus the assembly of the present invention is completed, as shown in FIG. 3.

In the present invention, the L shape adhering portion 31 of the vibration diaphragm 3 is adhered to the sound ring 2 three-dimensionally. Thereby in vibration, the sound ring 2 will not separate from the vibration diaphragm 3. Not only the fault rate is decreased, but also the power-tolerance of the speaker is increased.

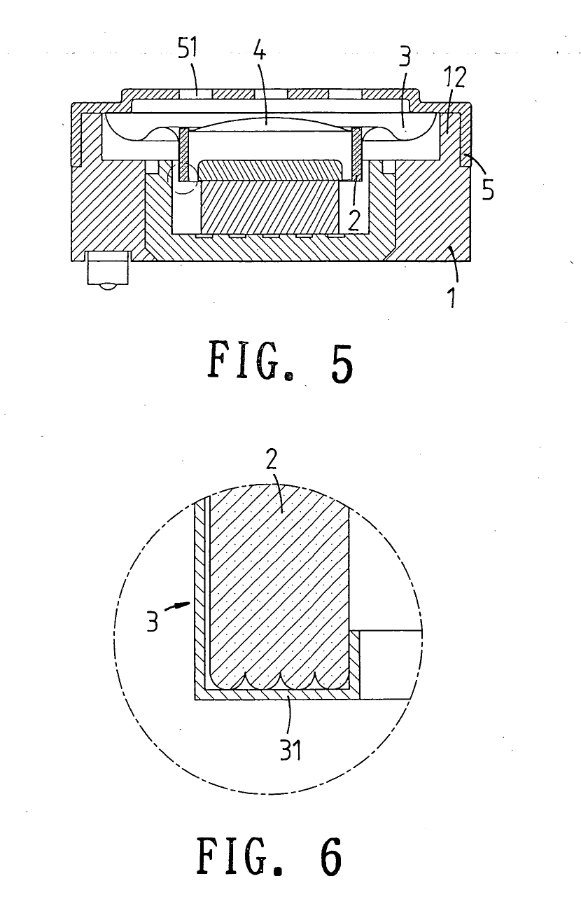

Referring to FIGS. 5 and 6, the second embodiment of the present invention is illustrated. Those same as the first embodiment will not be described. Only the difference of the two is described herein. To firmly secure the sound ring 2 to the vibration diaphragm 3, each lateral side of the vibration diaphragm 3 has a U shape so as to be adhered to the outer side, lower side and inner side of the sound ring 2 to increase the combination strength and the power-endurance of the vibration diaphragm 3 and the sound ring 2.

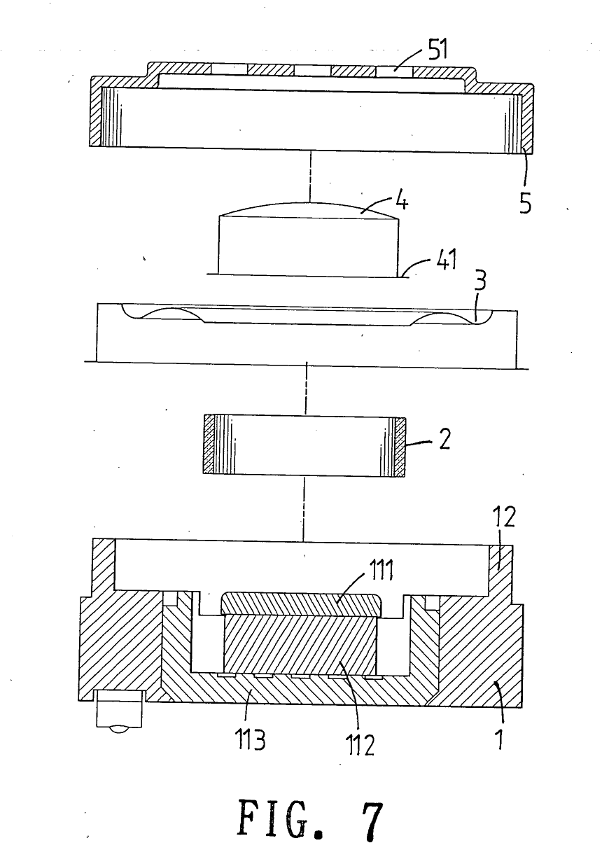

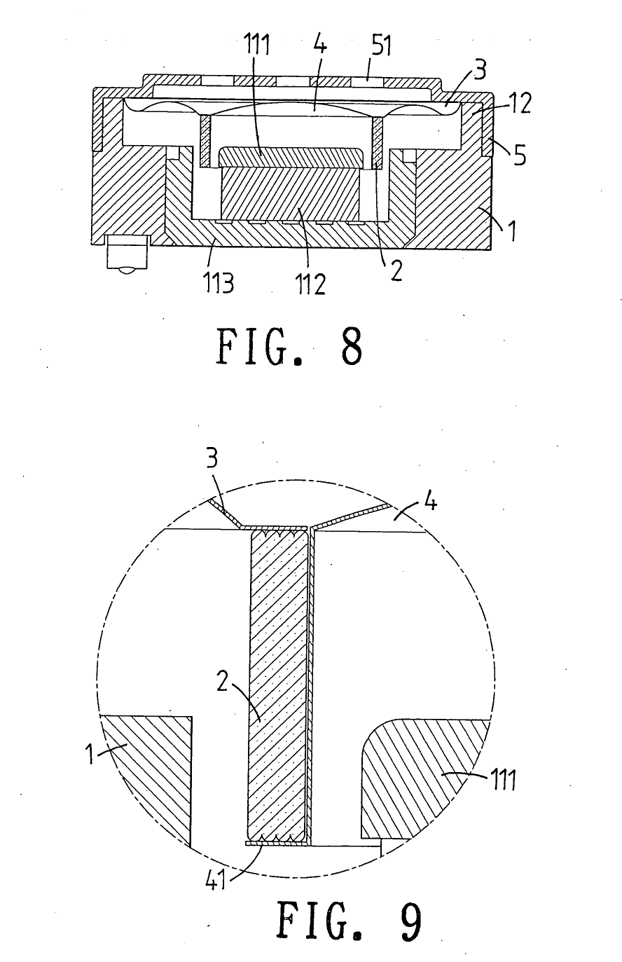

Referring to FIGS. 7 to 9, the third embodiment of the present invention is illustrated. Those same as the first embodiment will not be described. Only the difference of the two is described herein. A lower end of the dust-proof cover 4 is formed as an L shape annular adhering portion 41. The adhering portion 41 serves to adhere to the lower side and inner side of the sound ring 2 tightly. A center of the vibration diaphragm 3 is formed with a plane corresponding to the upper side of the sound ring 2 and being fixed to the upper side of the sound ring 2.

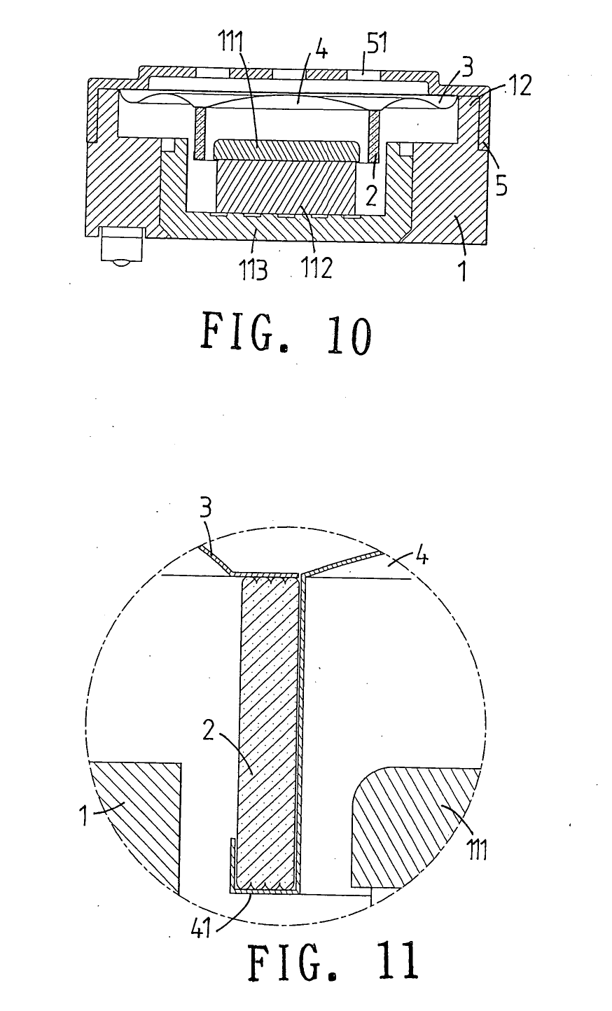

Referring to FIGS. 10 and 11, the fourth embodiment of the present invention is illustrated. Those same as the first embodiment will not be described. Only the difference of the two is described herein. A lower end of the dust-proof cover 4 is formed as, a U shape annular adhering portion 41. The adhering portion 41 serves to adhere to the lower side and inner side of the sound ring 2 tightly so as to increase the combining strength and the power-endurance of the dust-proof cover 4 and the sound ring 2.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power-tolerant assembly for combining a sound ring and a diaphragm of a speaker comprising:
a disk frame having a magnetic inducing body at a center thereof for generating magnetic field;
a vibration diaphragm installed upon the disk frame; the vibration diaphragm having an annular lower ring section; a distal end of the annular lower ring section being bent as an L shape; and
a sound ring within the vibration diaphragm; the magnetic inducing body being located below the sound ring; two sides of the sound ring being combined to the L shape distal end of the vibration diaphragm for increasing the combining area and strength of the combination of the adhering portion and the sound ring.

2. The power-tolerant assembly for combining a sound ring and a diaphragm of a speaker as claimed in claim 1, wherein a dust-proof cover is installed at an upper side of the sound ring.

3. The power-tolerant assembly for combining a sound ring and a diaphragm of a speaker as claimed in claim 1, wherein an upper side of the disk frame is formed with a positioning portion for positioning the vibration diaphragm.

4. The power-tolerant assembly for combining a sound ring and a diaphragm of a speaker as claimed in claim 1, wherein the magnetic inducing body is formed by an electrode sheet, a lower sheet and a magnet.

5. The power-tolerant assembly for combining a sound ring ,and a diaphragm of a speaker as claimed in claim 1, wherein a front cover covers upon the disk frame for protecting elements of the speaker.

6. The power-tolerant assembly for combining a sound ring and a diaphragm of a speaker as claimed in claim 5, wherein a center of the front cover has at least one sound hole.

7. A power-tolerant assembly for combining a sound ring and a diaphragm of a speaker comprising:
a disk frame having a magnetic inducing body at a center thereof for generating magnetic field;
a vibration diaphragm installed upon the disk frame; the vibration diaphragm having an annular lower ring section; a distal end of the annular lower ring section being bent as a U shape; and
a sound ring installed between the disk frame and the vibration diaphragm; the magnetic inducing body being located below the sound ring; three sides of the sound ring being combined to the U shape distal end of the vibration diaphragm for increasing the combining area and strength of the combination of the adhering portion and the sound ring.

8. The power-tolerant assembly for combining a sound ring and a diaphragm of a speaker as claimed in claim 7, wherein a dust-proof cover is installed at an upper side of the sound ring.

9. The power-tolerant assembly for combining a sound ring and a diaphragm of a speaker as claimed in claim 7, wherein an upper side of the disk frame is formed with a positioning portion for positioning the vibration diaphragm.

10. The power-tolerant assembly for combining a sound ring and a diaphragm of a speaker as claimed in claim 7, wherein the magnetic inducing body is formed by an electrode sheet, a lower sheet and a magnet.

11. The power-tolerant assembly for combining a sound ring and a diaphragm of a speaker as claimed in claim 7, wherein a front cover covers upon the disk frame for protecting elements of the speaker.

12. The power-tolerant assembly for combining a sound ring and a diaphragm of a speaker as claimed in claim 11, wherein a center of the front cover has at least one sound hole.

13. A power-tolerant assembly for combining a sound ring and a diaphragm of a speaker comprising:
a disk frame having a magnetic inducing body at a center thereof for generating magnetic field;
a vibration diaphragm installed upon the disk frame;
a sound ring installed within the vibration diaphragm; the magnetic inducing body being located below the sound ring;
a dust-proof cover installed upon an upper side of the sound ring; the vibration diaphragm having an annular lower side; a lower distal end of the annular lower end being bent so as to enclose the sound ring for increasing the combining area and strength of the combination of the adhering portion and the sound ring.

14. The power-tolerant assembly for combining a sound ring and a diaphragm of a speaker as claimed in claim 13, wherein the lower distal end of the annular lower end is bent as an L shape; two sides of the sound ring being combined to the L shape distal end of the vibration diaphragm.

15. The power-tolerant assembly for combining a sound ring and a diaphragm of a speaker as claimed in claim 13, wherein the lower distal end of the annular lower end is bent as a U shape; three sides of the sound ring being combined to the U shape distal end of the vibration diaphragm.

16. The power-tolerant assembly for combining a sound ring and a diaphragm of a speaker as claimed in claim 13, wherein an upper side of the disk frame is formed with a positioning portion for positioning the vibration diaphragm.

17. The power-tolerant assembly for combining a sound ring and a diaphragm of a speaker as claimed in claim 13, wherein the magnetic inducing body is formed by an electrode sheet, a lower sheet and a magnet.

18. The power-tolerant assembly for combining a sound ring and a diaphragm of a speaker as claimed in claim 13, wherein a front cover covers upon the disk frame for protecting elements of the speaker.

19. The power-tolerant assembly for combining a sound ring and a diaphragm of a speaker as claimed in claim 18, wherein a center of the front cover has at least one sound hole.
